(19) United States
(12) Patent Application Publication
(10) Pub. No.: US 2025/0363601 A1
(43) Pub. Date: Nov. 27, 2025

(54) IMAGE SENSOR, APPARATUS AND METHOD FOR PROCESSING IMAGES

(71) Applicant: SAMSUNG ELECTRONICS CO., LTD., Suwon-si (KR)

(72) Inventors: Wonju Seo, Suwon-si (KR); Yongjoon Song, Suwon-si (KR); Hansol Lee, Suwon-si (KR); Yeolmin Seong, Suwon-si (KR); Jihyun Yoo, Suwon-si (KR)

(73) Assignee: SAMSUNG ELECTRONICS CO., LTD., Suwon-si (KR)

(21) Appl. No.: 18/989,846

(22) Filed: Dec. 20, 2024

(30) Foreign Application Priority Data
May 24, 2024 (KR) 10-2024-0068119

(51) Int. Cl. G06T 5/70; G06T 3/4015; G06T 5/73; G06T 7/12; G06V 10/60; G06V 40/16

(52) U.S. Cl. CPC G06T 5/70; G06T 3/4015; G06T 5/73; G06T 7/12; G06V 10/60; G06V 40/161; G06T 2207/10024; G06T 2207/30201

(57) ABSTRACT

Provided is an apparatus for processing images, the apparatus including: a pixel array configured to correspond to a first color pattern and to convert a received optical signal into an electrical signal; a readout circuit configured to convert the electrical signal into first image data associated with the first color pattern and to output the first image data; a memory storing instructions; and a processor configured to execute the instructions, wherein the one or more instructions, when executed by the at least one processor, cause the apparatus to: receive the first image data, acquire at least one of noise reduction information or sharpness information associated with the first image data, input the first image data and at least one of the noise reduction information or the sharpness information into a machine learning model to generate a first RGB image, and output the first RGB image.

### CROSS-REFERENCE TO RELATED APPLICATION

This application is based on and claims priority to Korean Patent Application No. 10-2024-0068119, filed in the Korean Intellectual Property Office on May 24, 2024, the entire contents of which are hereby incorporated by reference.

### BACKGROUND

### 1. Field

The present disclosure relates to an image sensor, and an apparatus and a method for processing images.

### 2. Description of Related Art

Remosaicing may refer to an operation of converting image data associated with a specific color pattern into image data associated with another color pattern. For example, through remosaicing, non-Bayer image data such as image data associated with tetra pattern, etc. may be converted into images associated with the Bayer pattern.

Unlike related remosaic technologies (e.g., rule-based remosaicing), deep learning-based remosaic technologies train using a large amount of image data to identify the complex relationship between the original image and the remosaiced image, thereby providing an advantage of generating high-quality images. However, it can be difficult to perform remosaicing by reflecting various conditions, because models currently used are typically trained under fixed conditions.

### SUMMARY

Provided is an image sensor, and an apparatus and a method for processing images.

According to an aspect of the disclosure, an apparatus for processing images includes: a pixel array configured to correspond to a first color pattern and to convert a received optical signal into an electrical signal; a readout circuit configured to convert the electrical signal into first image data associated with the first color pattern and to output the first image data; at least one memory storing one or more instructions; and at least one processor configured to execute the one or more instructions, wherein the one or more instructions, when executed by the at least one processor, cause the apparatus to: receive the first image data, acquire at least one of noise reduction information or sharpness information associated with the first image data, input the first image data and at least one of the noise reduction information or the sharpness information into a machine learning model to generate a first RGB image, and output the first RGB image.

According to an aspect of the disclosure, an image processing method includes: obtaining an optical signal through a pixel array configured to correspond to a first color pattern; converting the optical signal to an electrical signal by the pixel array; converting, through a readout circuit, the electrical signal into first image data associated with the first color pattern; outputting, from the readout circuit, image data; receiving the image data; acquiring at least one of noise reduction information or sharpness information associated with the image data; generating an RGB image by inputting the image data and at least one of the noise reduction information or the sharpness information into a machine learning model; and outputting the RGB image.

According to an aspect of the disclosure, a non-transitory computer readable medium has instructions stored therein, which when executed by at least one processor cause the at least one processor to execute an image processing method including: obtaining an optical signal through a pixel array configured to correspond to a first color pattern; converting the optical signal to an electrical signal by the pixel array; converting, through a readout circuit, the electrical signal into first image data associated with the first color pattern; outputting, from the readout circuit, image data; receiving the image data; acquiring at least one of noise reduction information or sharpness information associated with the image data; generating an RGB image by inputting the image data and at least one of the noise reduction information or the sharpness information into a machine learning model; and outputting the RGB image.

The present disclosure is not limited to the foregoing, and other aspects not described herein can be understood by those of ordinary skill in the art from the following description and the appended claims.

### BRIEF DESCRIPTION OF THE DRAWINGS

The above and other aspects and features of certain embodiments of the present disclosure will be more apparent from the following description taken in conjunction with the accompanying drawings, in which:

FIGS. 1, 2 and 3 are diagrams illustrating an example of performing image processing according to one or more embodiments of the present disclosure;

FIG. 4 is a diagram illustrating examples of image data;

FIG. 5 is a diagram illustrating an example of a noise reduction map and a sharpness map;

FIG. 6 is a diagram illustrating an example of generating a noise reduction map and a sharpness map according to one or more embodiments of the present disclosure;

FIGS. 7 and 8 are diagrams illustrating examples of the noise reduction map and the sharpness map according to one or more embodiments of the present disclosure, and examples of an RGB image generated based on the noise reduction map and the sharpness map;

FIG. 9 is a flowchart illustrating a method for processing images according to one or more embodiments of the present disclosure;

FIG. 10 is a diagram illustrating an example of training data according to one or more embodiments of the present disclosure;

FIGS. 11, 12 and 13 are diagrams illustrating examples of training a machine learning model according to one or more embodiments of the present disclosure;

FIG. 14 is a flowchart illustrating an example of a method for training a machine learning model according to one or more embodiments of the present disclosure;

FIG. 15 is a block diagram illustrating an apparatus for processing images according to one or more embodiments of the present disclosure;

FIG. 16 is a block diagram illustrating an example of a computing system; and

FIG. 17 is a diagram illustrating a detailed example of image processing according to one or more embodiments of the present disclosure.

### DETAILED DESCRIPTION

Hereinafter, certain aspects of the present disclosure will be described as follows with reference to the accompanying drawings.

In the following description, like reference numerals refer to like elements throughout the specification. Terms such as “unit”, “module”, “member”, and “block” may be embodied as hardware or software. As used herein, a plurality of “units”, “modules”, “members”, and “blocks” may be implemented as a single component, or a single “unit”, “module”, “member”, and “block” may include a plurality of components.

It will be understood that when an element is referred to as being “connected” with or to another element, it can be directly or indirectly connected to the other element, wherein the indirect connection may include “connection via a wireless communication network”.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

As used herein, the expressions “at least one of a, b or c” and “at least one of a, b and c” indicate “only a,” “only b,” “only c,” “both a and b,” “both a and c,” “both b and c,” and “all of a, b, and c.”

It will be understood that, although the terms “first”, “second”, “third”, etc., may be used herein to describe various elements, is the disclosure should not be limited by these terms. These terms are only used to distinguish one element from another element.

As used herein, the singular forms “a,” “an” and “the” are intended to include the plural forms as well, unless the context clearly indicates otherwise.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

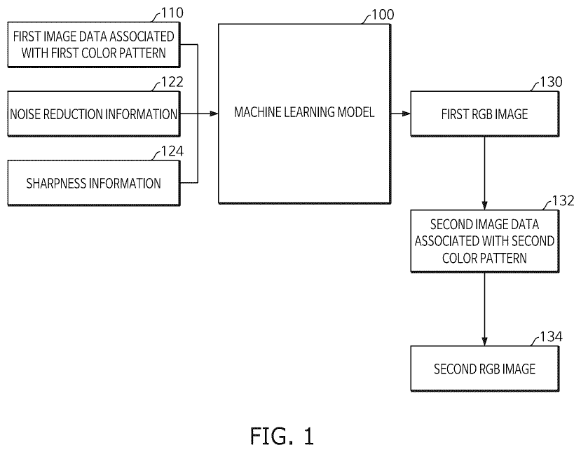

FIGS. 1 to 3 are diagrams illustrating an example of performing image processing according to one or more embodiments of the present disclosure.

Referring to FIGS. 1 to 3, an apparatus for processing images may receive first image data 110 associated with a first color pattern.

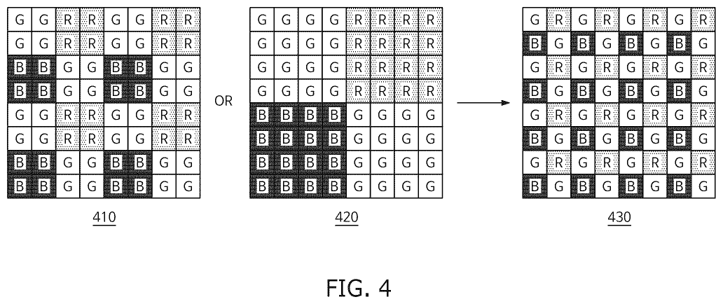

The apparatus for processing images may include an image sensor, and the image sensor may include a pixel array, a readout circuit, and at least one processor (e.g., an image signal processor). The apparatus for processing images may be a mobile phone, a tablet, a wearable device, etc. The image sensor may include a pixel array disposed to correspond to the first color pattern, and may generate the first image data 110 associated with the first color pattern. For example, the pixel array disposed to correspond to the first color pattern may convert received optical signals into electrical signals. The readout circuit may convert the electrical signals converted by the pixel array into the first image data 110 associated with the first color pattern. The processor may receive the first image data 110 associated with the first color pattern generated as described above. A specific example of the image data associated with the color pattern will be described below in more detail with reference to FIG. 4.

The apparatus for processing images may acquire noise reduction information 122 and/or sharpness information 124.

The noise reduction information 122 may include a denoising level applied to each of one or more regions of the first image data 110. For example, the noise reduction information 122 may include a denoising level applied to the entire region of the first image data 110. As another example, the noise reduction information 122 may include a plurality of denoising levels applied to each of the plurality of regions of the first image data 110. At least some of a plurality of denoising levels applied to each of a plurality of regions of the first image data 110 may be different from each other. The noise reduction information 122 may include a noise reduction map including a plurality of denoising levels applied to each of a plurality of regions of the first image data 110.

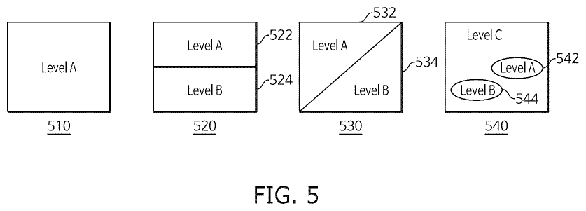

The sharpness information 124 may include a sharpening level applied to each of one or more regions of the first image data 110. For example, the sharpness information 124 may include a sharpening level applied to the entire region of the first image data 110. As another example, the sharpness information 124 may include a plurality of sharpening levels applied to each of the plurality of regions of the first image data 110. At least some of a plurality of sharpening levels applied to each of a plurality of regions of the first image data 110 may be different from each other. The sharpness information 124 may include a sharpness map including a plurality of sharpening levels applied to each of a plurality of regions of the first image data 110. A specific example of the noise reduction map and the sharpness map will be described below in more detail with reference to FIG. 5.

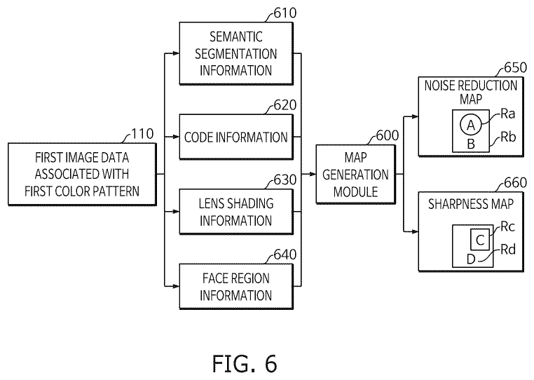

The processor of the apparatus for processing images may receive the noise reduction information 122 and/or the sharpness information 124 from another configuration or an external device of the apparatus for processing images. Additionally or alternatively, the apparatus for processing images may receive, through a user input, the noise reduction information 122 and/or the sharpness information 124. Additionally or alternatively, the apparatus for processing images may generate the noise reduction information 122 (e.g., a noise reduction map) and/or the sharpness information 124 (e.g., a sharpness map) based on the first image data 110. A specific example in which the apparatus for processing images generates the noise reduction map and/or the sharpness map will be described below in more detail with reference to FIG. 6.

The apparatus for processing images may generate a first RGB image 130, 230, and 330 by using a machine learning model 100, 200, and 300, based on the first image data 110 associated with the first color pattern, and the noise reduction information 122 and/or the sharpness information 124. In the first RGB image 130, 230, and 330, each pixel may be expressed as a combination of pixel values corresponding to the three color channels R, G, and B.

For example, as illustrated in FIG. 1, the apparatus for processing images may input the first image data 110, the noise reduction information 122, and the sharpness information 124 associated with the first color pattern to the machine learning model 100 to generate the first RGB image 130 with reduced noise and improved sharpness. A process of generating the first RGB image 130 with reduced noise and improved sharpness may be expressed by Equation 1 below.

$$\begin{matrix}y = {f}_{θ} ( x , {NR}_{map} , {sharp}_{m a p} ) , \\ x ∈ {ℝ}^{1 \times H \times W} , N {R}_{m a p} ∈ {ℝ}^{1 \times H \times W} , {sharp}_{m a p} ∈ {ℝ}^{1 \times H \times W} , y ∈ {ℝ}^{3 \times H \times W}\end{matrix} \qquad Equation 1$$

where, x may represent the first image data 110, NRₘₐₚ may represent the noise reduction map, sharpₘₐₚ may represent the sharpness map, f_{θ} may represent the machine learning model 100, θ may represent a weight of the machine learning model 100, and y may represent the first RGB image 130. In Equation 1, the size of the noise reduction map and the size of the sharpness map may be the same as that of the first image data 110, but aspects are not limited thereto, and the size of the noise reduction map and/or the size of the sharpness map may be different from the size of the first image data 110. For convenience of explanation, it is assumed herein that the size of the noise reduction map and the size of the sharpness map are the same as the size of the first image data 110.

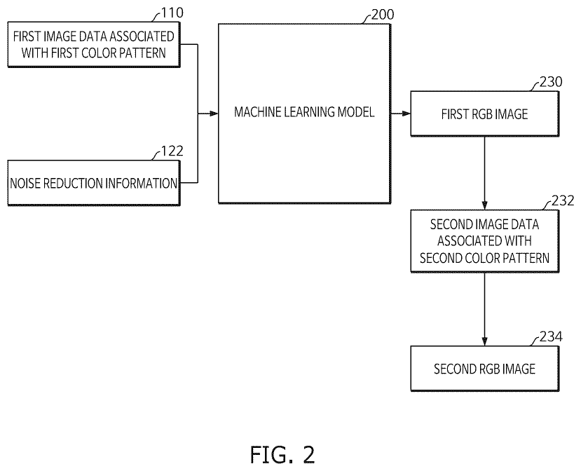

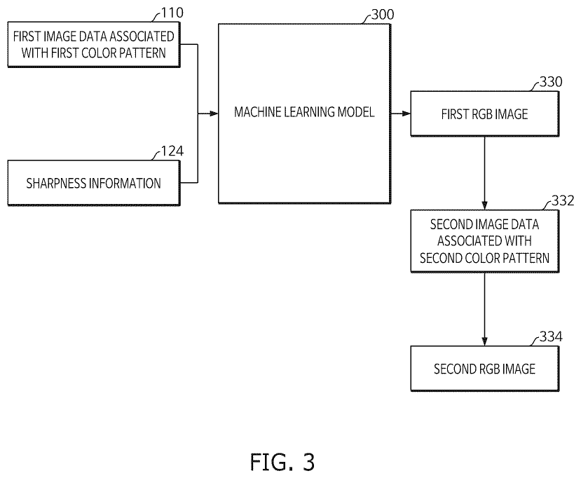

As another example, as illustrated in FIG. 2, the apparatus for processing images may input the first image data 110 and the noise reduction information 122 associated with the first color pattern to the machine learning model 200 to generate the first RGB image 230 with reduced noise. As another example, as illustrated in FIG. 3, the processor of the apparatus for processing images may input the first image data 110 and the sharpness information 124 associated with the first color pattern to the machine learning model 300 to generate the first RGB image 330 with improved sharpness.

The machine learning models 100, 200, and 300 may include an artificial neural network model. For example, the machine learning models 100, 200, and 300 may include an artificial neural network model such as UNet, ResNet, Vision Transformer, etc., but aspects are not limited thereto. The first image data 110 may be divided into a plurality of patches having the same size and input to the machine learning model 100, 200, and 300, and the first RGB image 130, 230, and 330 may be generated by merging the data output for each of the plurality of patches. Additionally or alternatively, the first image data 110, and the noise reduction information 122 and/or the sharpness information 124 may be input to the machine learning model 100, 200, and 300 in a concatenated state.

The apparatus for processing images may generate second image data 132, 232, and 332 associated with the second color pattern based on the generated first RGB image 130, 230, and 330. For example, the apparatus for processing images may generate the second image data 132, 232, and 332 associated with the second color pattern through a sampling operation of extracting pixel values associated with the second color pattern from the first RGB image 130, 230, and 330. The second color pattern associated with the second image data 132, 232, and 332 may be different from the first color pattern associated with the first image data 110. The second color pattern may include a Bayer pattern. In other words, the apparatus for processing images may generate the second image data 132, 232, and 332 associated with the Bayer pattern based on the first image data 110 associated with the color pattern other than the Bayer pattern. For example, the first color pattern may be a tetra pattern in which every four unit pixels in 2×2 array is matched with a color value of one of R, G, and B and construct a 4×4 Bayer pattern, a tetra square pattern (tetra² pattern) in which every sixteen unit pixels in 4×4 array is matched with a color value of one of R, G, and B and construct a 8×8 Bayer pattern, etc. This will be described below in detail with reference to FIG. 4.

An operation of generating the second image data 132, 232, and 332 associated with the second color pattern based on the first image data 110 associated with the first color pattern (e.g., tetra pattern, tetra2 pattern, etc.) may be referred to as a remosaic operation. Therefore, the machine learning model 100, 200, and 300 used during a series of processes of generating the second image data 132, 232, and 332 associated with the second color pattern based on the first image data 110 associated with the first color pattern may also be referred to as a remosaic model (or a remosaic network).

The apparatus for processing images may perform a demosaic operation on the second image data 132, 232, and 332 associated with the second color pattern (e.g., Bayer pattern) to generate a second RGB image 134, 234, and 334. For example, the apparatus for processing images may generate the second RGB image 134, 234, and 334 based on the second image data 132, 232, and 332 associated with the second color pattern using the demosaic model. In the second RGB image 134, 234, and 334, each pixel may be expressed as a combination of pixel values corresponding to the three color channels R, G, and B.

The apparatus for processing images may perform at least one of various image processing operations before and/or after performing the demosaic operation on the second image data 132, 232, and 332 associated with the second color pattern. For example, the image processing operation may include bad pixel correction (BPC) operation, lens shading correction (LSC) operation, X-talk correction operation, white balance (WB) correction operation, denoising operation, deblur operation, gamma correction operation, high dynamic range (TIDR) operation, tone mapping operation, etc. Additionally or alternatively, the machine learning model 100, 200, and 300 used in the remosaic operation may be used in the demosaic operation to generate the second RGB image 134, 234, and 334 based on the second image data 132, 232, and 332 associated with the second color pattern.

FIG. 4 is a diagram illustrating examples 410, 420, and 430 of image data. The first example 410 represents an example of image data associated with the first color pattern. For example, the first example 410 may be image data associated with the tetra pattern in which every four unit pixels in 2×2 array are matched with a color value of one of R, G, and B and construct a 4×4 Bayer pattern. As a specific example, in the first example 410, pixels in the first and second rows and in the first and second columns may have pixel values corresponding to light passed through the green color filter G. In addition, in the first example 410, pixels in the first and second rows and in the third and fourth columns may have pixel values corresponding to light passed through the red color filter R. In addition, in the first example 410, pixels in the third and fourth rows and included in the first and second columns may have pixel values corresponding to light passed through the blue color filter B. In addition, in the first example 410, pixels in the third and fourth rows and in the third and fourth columns may have pixel values corresponding to light passed through the green color filter G. As described above, the image data associated with the first color pattern may be image data in such a form that pixels in the first to fourth rows and in the first to fourth columns construct a 4×4 Bayer pattern, and this pattern repeats and expands up, down, left, and right.

The second example 420 represents an example of image data associated with the second color pattern. For example, the second example 420 may be image data associated with the tetra square pattern (tetra² pattern) in which every sixteen unit pixels in 4×4 array are matched with a color value of one of R, G, and B and construct a 8×8 Bayer pattern. As a specific example, in the second example 420, pixels in the first to fourth rows and in the first to fourth columns may have pixel values corresponding to light passed through the green color filter G. In addition, in the second example 420, pixels in the first to fourth rows and in the fifth to eighth columns may have pixel values corresponding to light passed through the red color filter R. In addition, in the second example 420, pixels in the fifth to eighth rows and in the first to fourth columns may have pixel values corresponding to light passed through the blue color filter B. In addition, in the second example 420, pixels in the fifth to eighth rows and in the fifth to eighth columns may have pixel values corresponding to light passed through the green color filter G. As described above, the image data associated with the second color pattern may be image data in such a form that pixels in the first to eighth rows and in the first to eighth columns construct a 8×8 Bayer pattern, and this pattern repeats and expands up, down, left, and right.

The third example 430 represents an example of image data associated with the third color pattern. For example, in the third example 430, pixels in the first row and the first column may have pixel values corresponding to light passed through the green color filter G. In addition, in the third example 430, pixels in the first row and the second column may have pixel values corresponding to light passed through the red color filter R. In addition, in the third example 430, pixels in the second row and the first column may have pixel values corresponding to light passed through the blue color filter B. In addition, in the third example 430, pixels in the second row and the second column may have pixel values corresponding to light passed through the green color filter G. Specifically, for example, the third color pattern may be a Bayer pattern. The image data associated with the third color pattern may be image data in such a form that the pattern described above repeats and expands up, down, left, and right.

The apparatus for processing images may perform a remosaic operation of generating second image data associated with another color pattern different from a specific color pattern, based on the first image data associated with the specific color pattern. For example, an image sensor included in the apparatus for processing images may include a pixel array disposed to correspond to a specific color pattern (e.g., a tetra pattern or a tetra2 pattern, etc.). In this case, the image sensor may generate first image data (e.g., the image data illustrated in the first example 410 or the image data illustrated in the second example 420) associated with the specific color pattern. The processor may receive the first image data associated with the specific color pattern and generate second image data (e.g., the image data illustrated in the third example 430, etc.) associated with another color pattern (e.g., a Bayer pattern, etc.) different from the specific color pattern.

The examples 410, 420, and 430 of the image data associated with the color pattern illustrated and described in FIG. 4 are merely examples, and aspects are not limited thereto. In some aspects, the image data may be associated with any color pattern that is not illustrated or described in FIG. 4 (e.g., a Nona pattern in which every nine unit pixels in 3×3 array are matched with a color value of one of R, G, and B and construct a 6×6 Bayer pattern, etc.).

Although FIG. 4 illustrates a color pattern matched with a color value of one of R, G, and B, aspects are not limited thereto, and a color pattern matched with various color values may be used. For example, a color pattern matched with a color value of one of R, G, B, and W may be used.

FIG. 5 is a diagram illustrating an example of a noise reduction map and a sharpness map. The noise reduction map may include a denoising level applied to each of one or more regions of the image data. The denoising level may represent a degree of noise reduction in the image data. For example, the denoising level may be a number in a first predefined range. For example, the denoising level may be a number ranging from 1 to 10, but aspects are not limited thereto. As the denoising level increases, more noise may be reduced in the region where the corresponding denoising level is applied, resulting in a relatively cleaner image, and as the denoising level decreases, less noise may be reduced in the region where the denoising level is applied, resulting in an image with a relatively more noise remaining therein.

The sharpness map may include a sharpening level applied to each of one or more regions of the image data. The sharpening level may represent a degree of sharpness improvement in the image data. The term “sharpness” as used herein may refer to a characteristic indicating how clearly the boundaries and details in the image are visible. For example, the sharpening level may be a number in a second predefined range. As a specific example, the sharpening level may be a number ranging from 0 to 1, but aspects are not limited thereto. As the sharpening level increases, sharpness may be further improved in a region where the sharpening level is applied, resulting in an image with a relatively more crisp and clearer details, and as the sharpening level decreases, sharpness may be less improved in the region where the corresponding sharpening level is applied, resulting in a relatively less clearer and smoother image.

The noise reduction map may include a denoising level applied to the entire region of the image data. For example, the noise reduction map may include one denoising level (Level A in a first example 510) applied to the entire region of image data, as illustrated in the first example 510. If the noise reduction map according to the first example 510 is used, the degree of noise reduction may be the same throughout the region of the image data.

Likewise, the sharpness map may include a sharpening level applied to the entire region of image data. For example, the sharpness map may include one sharpening level applied to the entire region of image data as illustrated in the first example 510. If the sharpness map according to the first example 510 is used, the degree of sharpness improvement may be the same throughout the entire region of the image data.

According to another aspect, the noise reduction map may include a plurality of denoising levels applied to each of the plurality of regions of the image data. For example, the noise reduction map may include a plurality of denoising levels (Level A and Level B in a second example 520 and a third example 530, and Level A, Level B, and Level C in a fourth example 540) applied to each of regions 522, 524, 532, 534, 542, and 544 of the image data, as illustrated in the second example 520 and fourth example 540. At least some of the plurality of denoising levels may be different from each other. As illustrated in the second to fourth examples 520 to 540, if at least some of the plurality of denoising levels applied to each of the regions of the image data use different noise reduction maps, the degrees of noise reduction may be different in at least some of each of the regions of the image data.

The sharpness map may include a plurality of sharpening levels applied to each of the plurality of regions of the image data. For example, the sharpness map may include a plurality of sharpening levels applied to each of the regions 522, 524, 532, 534, 542, and 544 of the image data as illustrated in the second to fourth examples 520 to 540. At least some of the plurality of sharpening levels may be different from each other. As illustrated in the second to fourth examples 520 to 540, if at least some of the plurality of sharpening levels applied to each of the regions of the image data use different sharpness maps, the degree of sharpness improvement may be different in at least some of each of the regions of the image data.

The examples 510, 520, 530, and 540 of the noise reduction map and/or sharpness map illustrated in FIG. 5 are merely examples, and the noise reduction map and/or sharpness map according to the present disclosure may have various level patterns as well as the level patterns of the examples illustrated in FIG. 5.

FIG. 6 is a diagram illustrating an example of generating a noise reduction map 650 and a sharpness map 660.

The apparatus for processing images may generate, based on the first image data 110 associated with the first color pattern, the noise reduction map 650 and/or the sharpness map 660 applied to the first image data 110. For example, the processor of the apparatus for processing images may include a map generation module 600. The map generation module 600 may acquire various information associated with the first image data 110, and generate the noise reduction map 650 and/or the sharpness map 660 based on the acquired information. Based on the acquired information, the map generation module 600 may generate the noise reduction map 650 including different denoising levels (Level A and Level B in the example of FIG. 6) for each of regions Rc and Rd, and/or the sharpness map 660 including different sharpening levels (Level C and Level D in the example of FIG. 6) for each of regions Rc and Rd. The regions Ra and Rb and the regions Rc and Rd may be the same or different from each other.

The apparatus for processing images may generate or acquire various information (e.g., semantic segmentation information, code information, lens shading information, face region information) associated with the first image data 110 used to generate the noise reduction map 650 and/or the sharpness map 660. The apparatus for processing images may perform any preprocessing operation (e.g., binning operation, etc.) on the first image data 110 and generate various information used to generate the noise reduction map 650 and/or the sharpness map 660 based on the preprocessed (e.g., binned) first image data 110.

The map generation module 600 may acquire semantic segmentation information associated with the first image data 110. For example, the map generation module 600 may perform semantic segmentation on the first image data 110 to generate semantic segmentation information 610. The semantic segmentation in the field of image processing may refer to a task of recognizing objects in an image and classifying them into classes (e.g., people, faces, trees, etc.) to which each of the objects belongs. For example, the semantic segmentation information may include information associated with a face region in the image data. As another example, the map generation module 600 may receive the semantic segmentation information 610 from another configuration of the apparatus for processing images or from an external device. The map generation module 600 may generate the noise reduction map 650 and/or the sharpness map 660 based on the acquired semantic segmentation information 610.

Additionally or alternatively, the map generation module 600 may acquire code information 620 associated with the first image data 110. The code information 620 may include information related to illuminance for each of the regions in the first image data 110. For example, a region associated with a high code value may be a region with high illuminance, and a region associated with a low code value may be a region with low illuminance. The map generation module 600 may generate the noise reduction map 650 and/or the sharpness map 660 based on the code information 620 associated with the first image data 110. For example, the map generation module 600 may generate the noise reduction map 650 that reflects application of a relatively low denoising level to a region associated with a relatively high code value and a relatively high denoising level to a region associated with a relatively low code value. Additionally or alternatively, the map generation module 600 may generate the sharpness map 660 that reflects application of a relatively high sharpening level to a region associated with a relatively high code value and a relatively low sharpening level to a region associated with a relatively low code value.

Additionally or alternatively, the map generation module 600 may acquire lens shading information 630 associated with the image sensor that generated the first image data 110. The map generation module 600 may generate the noise reduction map 650 and/or the sharpness map 660 based on the acquired lens shading information 630. For example, the map generation module 600 may identify a central region and an outer region of the first image data 110 based on the lens shading information 630. The map generation module 600 may generate the noise reduction map 650 that reflects application of a relatively low denoising level to the central region and a relatively high denoising level to the outer region. Additionally or alternatively, the map generation module 600 may generate the sharpness map 660 that reflects application of a relatively high sharpening level to the central region and a relatively low sharpening level to the outer region.

Additionally or alternatively, the map generation module 600 may acquire face region information 640 associated with the first image data 110. For example, the apparatus for processing images (e.g., at least one processor of the apparatus for processing images) may identify a face region in the first image data 110 (or the preprocessed first image data 110, etc.), and the map generation module 600 may acquire the face region information 640. The face region information 640 may include hair region information. The map generation module 600 may generate the noise reduction map 650 and/or the sharpness map 660 based on the acquired face region information 640. In the noise reduction map 650, the face region and a region other than the face region may have different denoising levels from each other. In addition, in the sharpness map 660, the face region and the region other than the face region may have different sharpening levels from each other.

For example, the map generation module 600 may generate the noise reduction map 650 that reflects application of a relatively high denoising level to a face region and a relatively low denoising level to at least part of the region other than the face region. In another example, the map generation module 600 may generate the noise reduction map 650 that reflects application of a relatively low denoising level to the face region and a relatively high denoising level to at least part of the region other than the face region. Additionally or alternatively, the map generation module 600 may generate the sharpness map 660 that reflects application of a relatively high sharpening level to the face region and a relatively low sharpening level to at least part of the region other than the face region.

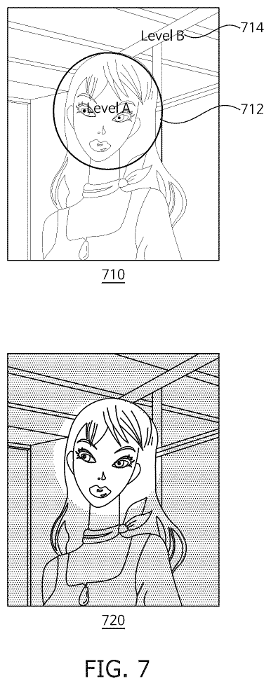

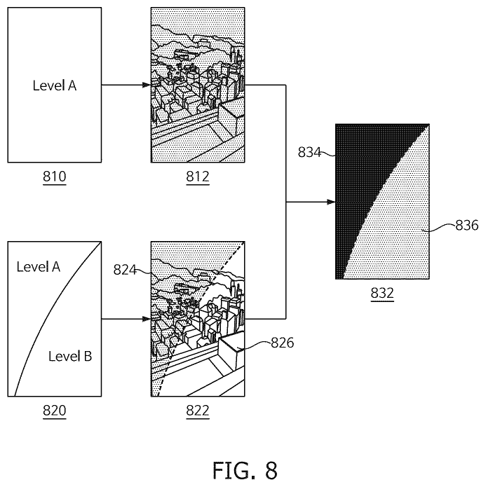

FIGS. 7 and 8 are diagrams illustrating examples of the noise reduction map and the sharpness map according to one or more embodiments of the present disclosure, and examples of an RGB image generated based on the noise reduction map and the sharpness map. Although the RGB image illustrated in FIGS. 7 and 8 is schematically illustrated as a one-channel image for convenience of description, this is only for convenience of explanation, and in actual implementation, the RGB image may be implemented as an image including data of three channels R, G, and B.

Referring to FIG. 7, a first example 710 illustrates an example of a noise reduction map and/or an example of a sharpness map generated based on the face information associated with the image data. A second example 720 represents an example of an RGB image generated based on the noise reduction map and/or the sharpness map of the first example 710.

The first example 710 may be an example of the noise reduction map generated based on the face region information associated with the image data. For example, the noise reduction map may be generated, which may apply a first denoising level (Level A in the first example 710) to a face region 712 of the image data and a second denoising level (Level B in the first example 710) to at least some of region 714 other than the face region. The first denoising level and the second denoising level may be different from each other. The second example 720 may be an example of an RGB image with reduced noise, which is generated based on the noise reduction map of the first example 710. For convenience of understanding, the second example 720 may schematically represent an image in which different regions are denoised at different levels. For example, the RGB image with reduced noise in the second example 720 may be an image in which the region 714 other than the face region and the face region 712 are denoised at different levels.

Additionally or alternatively, the second example 720 may be an example of a sharpness map generated based on the face region information associated with the image data. For example, the sharpness map may be generated, which may apply a first sharpness level (Level A in the second example 720) to the face region 712 of image data and a second sharpness level (Level B in the second example 720) to the region 714 other than the face region. The first sharpness level and the second sharpness level may be different from each other. The second example 720 may be an example of an RGB image with improved sharpness, which is generated based on the sharpness map of the second example 720. The second example 720 may schematically represent an image in which different regions are subjected to different levels of sharpening processing for convenience of understanding. For example, the RGB image with improved sharpness in the second example 720 may be an image in which the region 714 other than the face region and the face region 712 are subjected to different levels of sharpening processing.

Referring to FIG. 8, a third example 810 illustrates an example of a noise reduction map, and a fourth example 812 illustrates an example of the RGB image with reduced noise, which is generated based on the noise reduction map of the third example 810. The third example 810 may be a noise reduction map that reflects application of the first denoising level (Level A in the third example 810) uniformly throughout the entire region of the image data. The fourth example 812 generated based on the noise reduction map of the third example 810 may be an example of an RGB image having the same degree of noise reduction throughout the entire region for convenience of understanding.

A fifth example 820 illustrates an example of the noise reduction map, and a sixth example 822 illustrates an example of the RGB image with reduced noise, which is generated based on the noise reduction map of the fifth example 820. The fifth example 820 may be the noise reduction map that reflects application of a first denoising level (Level A in the fifth example 820) to a first region 824 and a second denoising level (Level B in the fifth example 820) higher than the first denoising level to a second region 826. The sixth example 822 generated based on the noise reduction map of the fifth example 820 may be an example of an RGB image in which noise is reduced more in the second region 826 than in the first region 824 for convenience of understanding.

A seventh example 832 may be an example of an image representing a difference value between the fourth example 812 and the sixth example 822. In the fourth example 812 and the sixth example 822, a first region 834 of the seventh example 832, where the same denoising level is applied, may have a value 0 because there is no difference on the RGB image. This region may be displayed in black in the seventh example 832. In the fourth example 812 and the sixth example 822, a second region 836 of the seventh example 832, where different denoising levels are applied, may have a value other than zero because there is a difference on the RGB image.

Through the seventh example 832, it can be visually confirmed that different denoising levels are applied to the first region 834 and the second region 836.

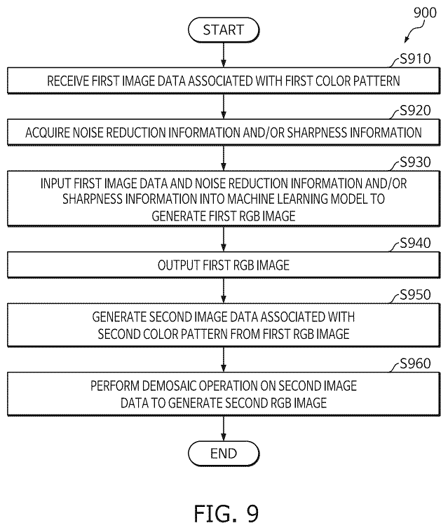

FIG. 9 is a flowchart illustrating a method 900 for processing images. The method 900 for processing images may be performed by a processor (e.g., at least one application processor (AP), an image signal processor (ISP), a neural network processor (NNP, etc.) of the apparatus for processing images, and at least one processor (ISP, etc.) of the image sensor).

The processor may receive first image data associated with a first color pattern, at S910. For example, an image sensor (e.g., an image sensor of an apparatus for processing images) may include a pixel array arranged to correspond to the first color pattern, and may generate the first image data associated with the first color pattern. The processor may receive the first image data associated with the first color pattern.

In addition, the processor may acquire noise reduction information and/or sharpness information, at S920. The noise reduction information may include a denoising level applied to each of one or more regions of the first image data. For example, the noise reduction information may include a denoising level applied to the entire region of the first image data. As another example, the noise reduction information may include a plurality of denoising levels applied to each of the plurality of regions of the first image data. At least some of a plurality of denoising levels applied to each of the plurality of regions of the first image data may be different from each other. The noise reduction information may include a noise reduction map including a plurality of denoising levels applied to each of the plurality of regions of the first image data.

The sharpness information may include a sharpening level applied to each of one or more regions of the first image data. For example, the sharpness information may include a sharpening level applied to the entire region of the first image data. As another example, the sharpness information may include a plurality of sharpening levels applied to each of the plurality of regions of the first image data. At least some of the plurality of sharpening levels applied to each of the plurality of regions of the first image data may be different from each other. The sharpness information may include a sharpness map including a plurality of sharpening levels applied to each of the plurality of regions of the first image data.

The processor may generate noise reduction information (e.g., noise reduction map) and/or sharpness information (e.g., sharpness map) based on the first image data.

For example, the processor may acquire semantic segmentation information associated with the first image data and generate a noise reduction map and/or a sharpness map based on the semantic segmentation information.

Additionally or alternatively, the processor may identify a face region in the first image data and generate a noise reduction map and/or a sharpness map based on the identified face region. For example, the processor may generate a noise reduction map that reflects application of the first denoising level to the face region of the first image data and applies the second denoising level to at least part of the region other than the face region of the first image data. The first denoising level may be different from the second denoising level. As another example, the processor may generate a sharpness map that reflects application of the first sharpening level to the face region of the first image data and applies the second sharpening level to at least a portion of the region other than the face region of the first image data. The first sharpening level may be different from the second sharpening level.

Additionally or alternatively, the processor may acquire code information associated with the first image data and generate a noise reduction map and/or a sharpness map based on the acquired code information. The code information may include illuminance related information for each of the regions in the first image data. For example, if a code value associated with the first region of the first image data is less than a code value associated with a second region different from the first region of the first image data, the first region may be a relatively low illumination region compared to the second region, and the second region may be a relatively high illumination compared to the first region. Based on code information, the processor may generate a noise reduction map that reflects application of a third denoising level to the first region of the first image data and applies a fourth denoising level higher than the third denoising level to the second region of the first image data. Additionally or alternatively, based on the code information, the processor may generate a sharpness map that reflects application of a third sharpening level to the first region of the first image data and applies a fourth sharpening level lower than the third sharpening level to the second region of the first image data.

Additionally or alternatively, the processor may acquire lens shading information associated with the image sensor that generated the first image data, and generate a noise reduction map and/or a sharpness map based on the acquired lens shading information. For example, the processor may identify a central region and an outer region of the first image data based on the lens shading information. The processor may generate a noise reduction map that reflects application of a fifth denoising level to the central region and a sixth denoising level higher than the fifth denoising level to the outer region. Additionally or alternatively, the processor may generate a sharpness map that reflects application of a fifth sharpening level to the central region and applies a sixth sharpening level lower than the fifth sharpening level to the outer region.

The processor may input the first image data associated with the first color pattern and the noise reduction information and/or the sharpness information into the machine learning model to generate a first RGB image, at S930. The first image data and the noise reduction information and/or the sharpness information may be input to the machine learning model in a concatenated state.

The processor may generate, from the generated first RGB image, second image data associated with the second color pattern, at S950. The second color pattern may be a color pattern different from the first color pattern. According to this configuration, the second color pattern may be a Bayer pattern. The processor may perform the demosaic operation on the second image data to generate a second RGB image, at S960.

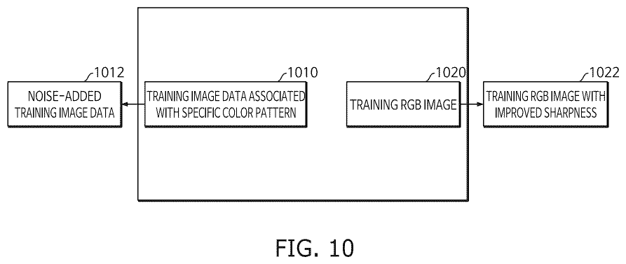

FIG. 10 is a diagram illustrating an example of training data. The apparatus for processing images may acquire and/or generate training data for training a machine learning model for image processing.

For example, the apparatus for processing images may acquire training image data 1010 associated with a specific color pattern and a training RGB image associated with the training image data 1010. For example, the specific color pattern may be a tetra pattern, a tetra2 pattern, etc.

In addition, the apparatus for processing images may acquire and/or generate training noise reduction information (e.g., training noise reduction map) and/or training sharpness information (e.g., training sharpness map). The training noise reduction information and/or training sharpness information may include a predetermined shape map (e.g., a map in the form of the first to third examples 410, 420, and 430 of FIG. 4) and/or a modified map in the form of the predetermined shape map (e.g., a map in which a map in the form of the first to third examples 410, 420, and 430 of FIG. 4 is flipped and/or rotated).

The apparatus for processing images may generate noise-added training image data 1012 based on the training image data 1010 and the training noise reduction information. Additionally or alternatively, the apparatus for processing images may generate a training RGB image 1022 with improved sharpness based on a training RGB image 1020 and the training sharpness information.

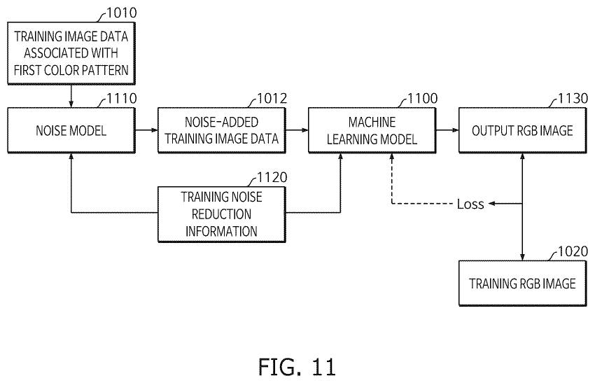

The apparatus for processing images may train the machine learning model by using the acquired and/or generated training data. This will be described below in detail with reference to FIGS. 11 to 13.

FIGS. 11 to 13 are diagrams illustrating examples of training a machine learning model 1100, 1200, and 1300 according to one or more embodiments of the present disclosure.

The apparatus for processing images may train a machine learning model to generate an output RGB image based on input image data associated with a specific color pattern and input noise reduction information and/or input sharpness information.

The apparatus for processing images may train the machine learning model 1100 to generate the training RGB image 1020 based on the noise-added training image data 1012 and training noise reduction information 1120. For example, as illustrated in FIG. 11, the apparatus for processing images may use the noise model 1110 to generate the noise-added training image data 1012 based on the training image data 1010 and the training noise reduction information 1120 associated with a specific color pattern. The noise model 1110 may include a noise injection model for injecting noise into an image. First, the apparatus for processing images may input the training image data 1010 into a noise generation model to generate noise. For example, the noise generation model may include a Poisson distribution-based noise generation model, a Gaussian distribution-based noise generation model, etc., but is not limited thereto. The apparatus for processing images may generate the noise-added training image data 1012 based on the training image data 1010, the training noise reduction information 1120, and the generated noise. As a specific example, the apparatus for processing images may perform an element-wise-product on the generated noise and training noise reduction map and add the result to the training image data 1010 to generate the noise-added training image data 1012. For example, the process in which the apparatus for processing images generates the noise-added training image data 1012 based on the training image data 1010 and the training noise reduction information 1120 may be expressed by Equation 2 below.

$${x}^{′} = x + N M ( x ) ⊙ {NR}_{m a p} \qquad Equation 2$$

where, x may represent the training image data 1010, NM(⋅) may represent a noise generation model, NRₘₐₚ may represent a training noise reduction map, ⊚ may represent element-wise-product, and x′ may represent the noise-added training image data 1012.

The apparatus for processing images may calculate a first loss based on RGB image 1130 and the training RGB image 1020 that are output when the noise-added training image data 1012 and the training noise reduction information 1120 are input to the machine learning model 1100. The apparatus for processing images may update the weight of the machine learning model 1100 so as to minimize the first loss, thereby training the machine learning model 1100.

According to this training, the machine learning model (e.g., the machine learning model 200 illustrated in FIG. 2) may be generated, which outputs the RGB image with reduced noise based on input image data and input noise reduction information associated with a specific color pattern.

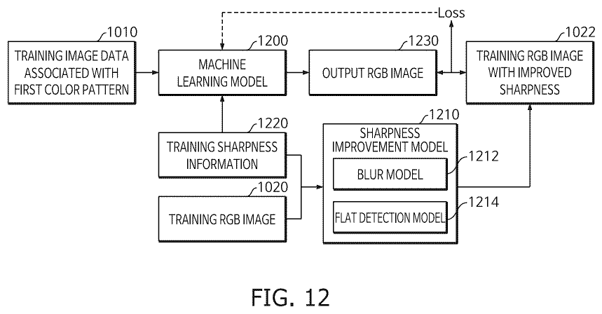

Additionally or alternatively, the apparatus for processing images may train the machine learning model 1200 to generate the training RGB image 1022 with improved sharpness based on the training image data 1010 and training sharpness information 1220. For example, as illustrated in FIG. 12, the apparatus for processing images may use a sharpness improvement model 1210 to generate the training RGB image 1022 with improved sharpness based on the training RGB image 1020 and the training sharpness information 1220. The sharpness improvement model 1210 may include a blur model 1212. For the blur model 1212, any blur model such as, for example, a Gaussian blur model or an artificial neural network blur model, etc. may be used. The apparatus for processing images may input the training RGB image 1020 to the blur model 1212 to generate a blur-processed training RGB image. In addition, the apparatus for processing images may reduce the blur-processed training RGB image from the training RGB image 1020 to extract a high-frequency component of the training RGB image 1020. The apparatus for processing images may generate the training RGB image 1022 with improved sharpness based on the training RGB image 1020, the training sharpness information 1220, and the high frequency components of the training RGB image 1020. As a specific example, the apparatus for processing images may perform an element-wise-product on the high frequency component of the training RGB image 1020 and the training sharpness map, multiply by a hyperparameter, and add the result value to the training RGB image 1020, thereby generating the training RGB image 1022 with improved sharpness. For example, the process in which the apparatus for processing images generates the training RGB image 1022 with improved sharpness based on the training RGB image 1020 and the training sharpness information 1220 may be expressed by Equation 3 below.

$$G {T}^{′} = G T + α \times {Sharp}_{m a p} ⊙ ( GT - Blur ( GT ) ) \qquad Equation 3$$

where, GT may represent the training RGB image 1020, Blur(⋅) may represent the blur model 1212, Sharpₘₐₚ may represent a training sharpness map, ⊚ may represent an elemene-wise-product, a may represent a hyperparameter, and GT′ may represent the training RGB image 1022 with improved sharpness.

The sharpness improvement model 1210 may further include a flat detection model 1214. The flat detection model 1214 may be a model for detecting a low frequency region such as a plane in an image. When generating the training RGB image 1022 with improved sharpness, the apparatus for processing images may not perform the sharpening on the region detected as the low frequency region. For example, the process in which the apparatus for processing images generates the training RGB image 1022 with improved sharpness using the sharpness improvement model 1210 including the flat detection model 1214 may be expressed as Equation 4 below.

$$G {T}^{′} = G T + α \times {Sharp}_{m a p} ⊙ FD ( GT ) ⊙ ( GT - Blur ( GT ) ) \qquad Equation 4$$

where, GT may represent the training RGB image 1020, Blur(⋅) may represent the blur model 1212, FD(⋅) may represent the flat detection model 1214 in which a region detected as a low frequency region is modeled as 0, and a region not detected as the low frequency region is modeled as 1, Sharpₘₐₚ may represent a training sharpness map, ⊚ may represent an element-wise-product, α may represent a hyperparameter, and GT′ may represent the training RGB image 1022 with improved sharpness. In this way, when generating the training RGB image 1022 with improved sharpness using the sharpness improvement model 1210 including the flat detection model 1214, it is possible to prevent noise from being boosted in a low frequency region such as a plane.

The apparatus for processing images may calculate a second loss based on an RGB image 1230 and the training RGB image 1022 with improved sharpness that are output when the training image data 1010 and the training sharpness information 1220 are input to the machine learning model 1200. The apparatus for processing images may update the weight of the machine learning model 1200 so as to minimize the second loss, thereby training the machine learning model 1200.

According to this training, a machine learning model (e.g., the machine learning model 300 illustrated in FIG. 3) may be generated which outputs the RGB image with improved sharpness based on input image data and input sharpness information associated with a specific color pattern.

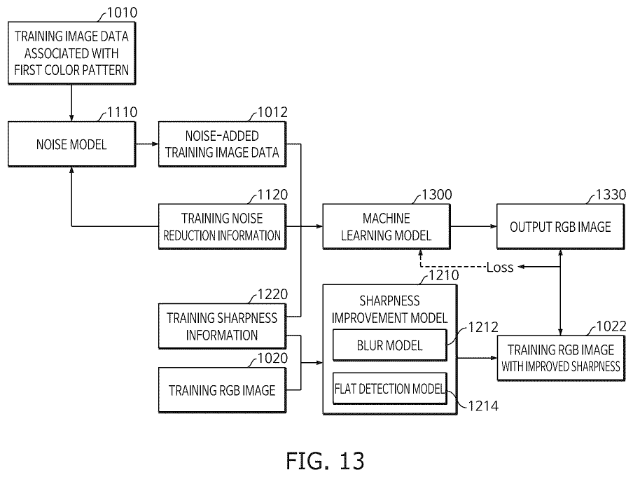

Additionally or alternatively, the apparatus for processing images may train the machine learning model 1300 to generate the training RGB image 1022 with improved sharpness based on the noise-added training image data 1012, the training noise reduction information 1120, and the training sharpness information 1220. For example, referring to FIG. 13, the apparatus for processing images may calculate a third loss based on an RGB image 1330 and the training RGB image 1022 with improved sharpness that are output when the noise-added training image data 1012, the training noise reduction information 1120, and the training sharpness information 1220 are input to the machine learning model. The apparatus for processing images may update the weight of the machine learning model 1300 so as to minimize the third loss, thereby training the machine learning model 1300.

According to this training, a machine learning model (e.g., the machine learning model 100 illustrated in FIG. 1) may be generated, which outputs RGB images with reduced noise and improved sharpness based on the input image data associated with a specific color pattern, the input noise reduction information, and the input sharpness information.

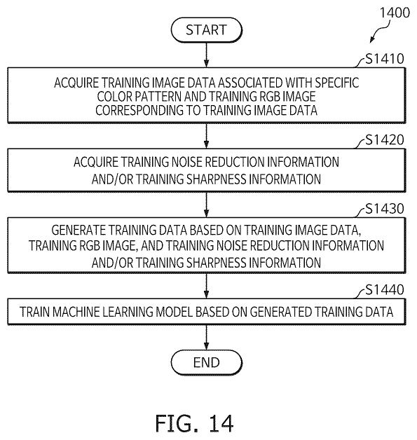

FIG. 14 is a flowchart illustrating an example of a method 1400 for training a machine learning model. The method 1400 may be performed by a processor (e.g., at least one processor of the apparatus for processing images, at least one processor of a computing system, etc.).

The processor may acquire training image data associated with a specific color pattern, and a training RGB image associated with the training image data, at S1410. In addition, the processor may acquire the training noise reduction information and/or the training sharpness information, at S1420.

The processor may generate training data based on the training image data, the training RGB image, and the training noise reduction information and/or the training sharpness information, at S1430. For example, the processor may generate noise-added training image data based on the training image data and the training noise reduction information. Additionally or alternatively, the processor may generate a training RGB image with improved sharpness based on the training RGB image and the training sharpness information.

The processor may train the machine learning model based on the generated training data, at S1440. The machine learning model may be trained to generate an output RGB image based on input image data associated with a specific color pattern, and input noise reduction information and/or input sharpness information.

For example, the processor may train a machine learning model to generate a training RGB image by using the noise-added training image data and the training noise reduction information. According to this training, a machine learning model may be generated which outputs the RGB image with reduced noise based on input image data and input noise reduction information associated with a specific color pattern.

As another example, the processor may train a machine learning model to generate a training RGB image with improved sharpness by using the training image data and the training sharpness information. According to this training, a machine learning model may be generated which outputs an RGB image with improved sharpness based on input image data and input sharpness information associated with a specific color pattern.

As another example, the processor may train a machine learning model to generate an improved training RGB image by using noise-added training image data, training noise reduction information, and training sharpness information. According to this training, a machine learning model may be generated which outputs an RGB image with reduced noise and improved sharpness based on input image data, input noise reduction information, and input sharpness information associated with a specific color pattern.

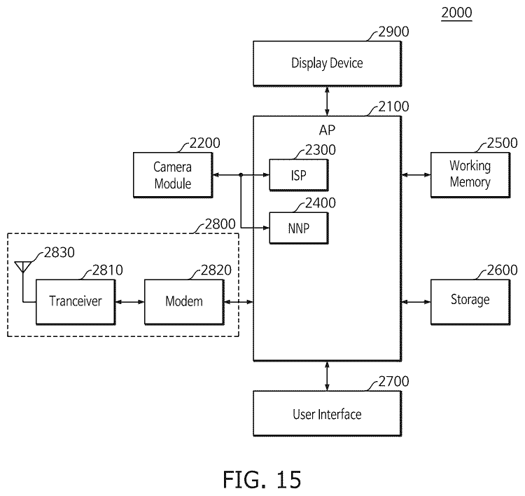

FIG. 15 is a block diagram illustrating an apparatus 2000 for processing images. The apparatus 2000 for processing images may be implemented as a part of a digital camera, a digital camcorder, a mobile phone, a tablet computer, or a portable electronic device. The portable electronic device may include a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a portable game console, an e-book, a wearable device, etc. In addition, the apparatus 2000 for processing images may be mounted on electronic devices such as drones and advanced drivers assistance systems (ADAS) or electronic devices equipped as components in vehicles, furniture, manufacturing facilities, doors, or various measuring devices.

Referring to FIG. 15, the apparatus 2000 for processing images may include an application processor 2100, a camera module 2200, a working memory 2500, a storage 2600, a user interface 2700, a wireless transceiver 2800, and a display device 2900. The application processor 2100 may include an image signal processor 2300 and a neural network processor 2400. FIG. 15 illustrates the image signal processor 2300 and the neural network processor 2400 included in the application processor 2100, but aspects are not limited thereto. According to another aspect, the image signal processor 2300 and/or the neural network processor 2400 may be implemented as an integrated circuit separate from the application processor 2100. Additionally or alternatively, the image signal processor 2300 and/or the neural network processor 2400 may be included in a component (e.g., the camera module 2200 or an image sensor included in the camera module 2200) other than the application processor 2100.

The camera module 2200 may include an image sensor that generates image data associated with a specific color pattern. The image sensor may convert light emitted or reflected from the subject into an electrical signal to generate image data corresponding to the subject. To this end, the image sensor may include a color filter array (pixel array) in which a plurality of color filters (pixels) are arranged in two dimensions. One color of a plurality of reference colors may be allocated to each of the plurality of color filters. For example, the plurality of reference colors may include RGB (red, green, and blue), or RGBW (red, green, blue, and white). The image sensor may be implemented by utilizing a charged coupled device (CCD) sensor or a complementary metal oxide semiconductor (CMOS) sensor, but is not limited thereto. The image data generated by the image sensor may be provided to the processor (e.g., the application processor 2100, the image signal processor 2300, and/or the neural network processor 2400) and/or stored in the working memory 2500 and/or the storage 2600.

The application processor 2100 may control the overall operation of the apparatus 2000 for processing images and drive an application program, an operating system, etc. The application processor 2100 may be provided as a system on chip (SoC). The application processor 2100 may control the operation of the image signal processor 2300 and the neural network processor 2400, and provide an image generated by the image signal processor 2300 and the neural network processor 2400 to the display device 2900 or store the image in the storage 2600. The method for processing images and/or the method for training a machine learning model according to aspects of the present disclosure described above with reference to FIGS. 1 to 14 may be performed by the application processor 2100, the image signal processor 2300, and/or the neural network processor 2400.

For example, the application processor 2100 may control the neural network processor 2400 to execute an application program and perform neural network-based tasks required according to the execution of the application program. The neural networks may be a neural network model based on at least one of Artificial Neural Network (ANN), Convolution Neural Network (CNN), Region with Convolution Neural Network (R-CNN), Region Proposal Network (RPN), Recurrent Neural Network (RNN), Stacking-based deep Neural Network (S-DNN), State-Space Dynamic Neural Network (S-SDNN), Deconvolution Network, Deep Belief Network (DBN), Restricted Boltzman Machine (RBM), Fully Convolutional Network, Long Short-Term Memory (LSTM) Network, Classification Network, Plain Residual Network, Dense Network, Hierarchical Pyramid Network, Fully Convolutional Network, but the types of neural network models are not limited to the examples described above.

The neural network processor 2400 may perform a neural network operation based on the received data. Furthermore, the neural network processor 2400 may generate an information signal based on a result of performing the neural network operation. The neural network processor 2400 may be implemented as a neural network operation accelerator, a coprocessor, a digital signal processor (DSP), an application specific integrated circuit (ASIC), a field-programmable gate array (FPGA), a graphics processing unit (GPU), a neural processing unit (NPU), a multi-processor system-on-chip (MPSoC), etc., but is not limited thereto.

The working memory 2500 may be implemented as a volatile memory such as DRAM or SRMA or a nonvolatile resistive memory such as FeRAM or RRAM PRAM. The working memory 2500 may store programs and/or data processed or executed by the application processor 2100.

The storage 2600 may be implemented as a nonvolatile memory device such as a NAND flash or a resistive memory, and for example, the storage 2600 may be provided as a memory card (MMC, eMMC, SD, micro SD), etc. The storage 2600 may store data and/or programs for an execution algorithm for controlling an image processing operation of the processors 2100, 2300, and 2400, and the data and/or the programs may be loaded into the working memory 2500 when the image processing operation is performed. The storage 2600 may store raw image data generated by an image sensor or images (data) (e.g., generated and converted images (data) or pre-processed and post-processed images (data), RGB images, etc.) generated by the processors 2100, 2300, and 2400.

The user interface 2700 may be implemented as various devices capable of receiving a user input, such as a keyboard, a curtain key panel, a touch panel, a fingerprint sensor, a microphone, etc. The user interface 2700 may receive a user input and provide a signal corresponding to the received user input to the application processor 2100. The wireless transceiver 2800 may include a transceiver 2810, a modem 2820, and an antenna 2830.

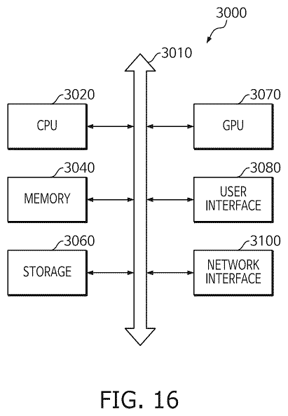

FIG. 16 is a block diagram illustrating an example of a computing system 3000. For example, the system 3000 of FIG. 16 may be used to implement some or all of the methods and/or devices described in the present disclosure. The system 3000 may include a central processing unit (CPU) 3020, a memory 3040, a storage 3060, a graphics processing unit (GPU) 3070, a user interface 3080, and a network interface 3100. In other aspects, to implement any method and/or device described in the present disclosure, the system may omit any of these components, or may include any other type of components as well as any components in duplicate or any number of additional components.

At least one processor (e.g., the CPU 3020, the GPU 3070, etc.) of the system 3000 may be used for the training operations of a machine learning model for image processing. In addition, at least one processor (e.g., the CPU 3020, the GPU 3070, etc.) of the system 3000 may be used to perform the method for processing images.

The CPU 3020 may include any number of cores, caches, buses and/or interconnect interfaces and/or controllers. The memory 3040 may include any device such as a dynamic and/or static RAM (DRAM, SRAM), a nonvolatile memory (e.g., a flash memory). The storage 3060 may include a hard disk drive (HDD), a solid state drive (SSD), and/or any other type of data storage device or any combination thereof. The user interface 3080 may include any type of human interface device, such as a keyboard, mouse, monitor, video capture or transmission device, microphone, speaker, and touch screen, as well as any virtualization or remote version of these devices. The network interface 3100 may include one or more adapters or other devices that communicate through Ethernet, Wi-Fi, Bluetooth, or any other computer networking facility, so that components may communicate through physical and/or logical networks such as intranet, Internet, local area networks, wide area networks, etc.

Some or all of the components of the system 3000 may be interconnected through a system bus 3010, which may collectively refer to various interfaces including power buses, address and data buses, Serial AT Attachment (SATA), Peripheral Component Interconnect (PCI), Peripheral Component Interconnect Express (PCI-e), System Management Bus (SMB), and high-speed interconnectors such as other types of interfaces that may enable the components to operate locally at one position and/or at different distributed positions.

The system 3000 may also include various chipsets, interfaces, adapters, glue-logic, embedded controllers such as programmable or non-programmable logic devices or arrays, application specific integrated circuits (ASICs), embedded computers, smart cards, etc., which are configured to operate with various components of the system 3000 to implement some or all of the methods and/or devices described in the present disclosure. Any component of the system 3000 may be implemented in hardware, software, firmware, or any combination thereof. Some or all of the components may be realized in a cloud-based implementation or distributed across multiple data centers through a virtualized form and/or flexible provisioning of resources in a data center, for example.

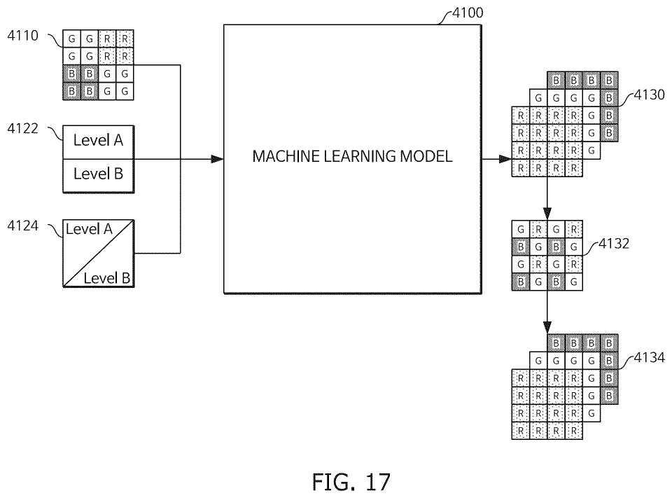

FIG. 17 is a diagram illustrating a detailed example of image processing.

Referring to FIG. 17, the apparatus for processing images may receive first image data 4110 associated with a first color pattern. For example, as illustrated in FIG. 17, the first color pattern may be a tetra pattern in which every four unit pixels in 2×2 array are matched with a color value of one of R, G, and B and construct a 4×4 Bayer pattern, but aspects are not limited thereto. In another aspect, the first color pattern may be any color pattern such as a tetra square pattern in which every sixteen unit pixels in 4×4 array is matched with a color value of one of R, G, and B and construct a 8×8 Bayer pattern, a Nona pattern in which every nine unit pixels in 3×3 array is matched with a color value of one of R, G, and B and construct a 6×6 Bayer pattern, etc.

The apparatus for processing images may acquire noise reduction information 4122 and/or sharpness information 4124. For example, as illustrated in FIG. 17, the noise reduction information 4122 may include a noise reduction map including a plurality of denoising levels (level A and level B in FIG. 17) applied to each of a plurality of regions of the first image data 4110, and the sharpness information 4124 may include a sharpness map including a plurality of sharpening levels (level A and level B in FIG. 17) applied to each of a plurality of regions of the first image data 4110, but aspects are not limited thereto. In another aspect, the noise reduction information 4122 may include one denoising level uniformly applied to the entire region of the first image data 4110, and/or the sharpness information 4124 may include one sharpening level uniformly applied to the entire region of the first image data 4110.

The apparatus for processing images may generate a first RGB image 4130 by using a machine learning model 4100, based on the first image data 4110 associated with the first color pattern, and the noise reduction information 4122 and/or the sharpness information 4124. In the first RGB image 4130, each pixel may be expressed as a combination of pixel values corresponding to the three color channels R, G, and B.

The apparatus for processing images may generate the second image data 4132 associated with the second color pattern through a sampling operation of extracting pixel values associated with a second color pattern from the first RGB image 4130. For example, the second color pattern may be a Bayer pattern, as illustrated in FIG. 17.

The apparatus for processing images may perform a demosaic operation on the second image data 4132 associated with the second color pattern (e.g., Bayer pattern) to generate a second RGB image 4134. In the second RGB image 4134, each pixel may be expressed as a combination of pixel values corresponding to the three color channels R, G, and B.

Operations of methods or algorithms and functions described in connection with the aspects disclosed herein may be implemented directly in hardware, one or more software modules executed by a processor, or a combination of the two, including the system 3000. If the operations are implemented in software, the function may be stored or transmitted as one or more types of instructions or codes in a non-transitory computer-readable medium. The software module may be in random access memory (RAM), flash memory, read only memory (ROM), electrically programmable ROM (EPROM), electrically erasable programmable ROM (EEPROM), registers, hard disks, removable disks, CD ROMs, or other forms of storage media. Any system, or components or a part thereof disclosed herein may be implemented as part of a larger system, e.g., a graphics processing unit (GPU) or as part of a software stack of another larger system. Any system, or components or a part thereof disclosed herein may be implemented as its own software stack.

As described above, certain aspects are disclosed in the drawings and specification. Although aspects have been described using specific terms in the present description, these terms are used only for the purpose of explaining the technical idea of the present disclosure and not to limit the meaning or the scope of the present disclosure described in the claims. Therefore, those with ordinary knowledge in the art will understand that various modifications and other equivalent aspects are possible. Therefore, the true technical protection scope of the present disclosure should be determined by the technical idea of the appended claims.

What is claimed is:

1. An apparatus for processing images, the apparatus comprising:
a pixel array configured to correspond to a first color pattern and to convert a received optical signal into an electrical signal;
a readout circuit configured to convert the electrical signal into first image data associated with the first color pattern and to output the first image data;
at least one memory storing one or more instructions; and
at least one processor configured to execute the one or more instructions,
wherein the one or more instructions, when executed by the at least one processor, cause the apparatus to:
receive the first image data,
acquire at least one of noise reduction information or sharpness information associated with the first image data,
input the first image data and at least one of the noise reduction information or the sharpness information into a machine learning model to generate a first RGB image, and
output the first RGB image.

2. The apparatus of claim 1,
wherein the noise reduction information comprises a denoising level, and
wherein the one or more instructions, when executed by the at least one processor, cause the apparatus to apply the denoising level to a region of the first image data.

3. The apparatus of claim 2,
wherein the first image data comprises a plurality of regions,
wherein the noise reduction information comprises a plurality of denoising levels,
wherein the one or more instructions, when executed by the at least one processor, cause the apparatus to apply a denoising level from among the plurality of denoising levels to each of the plurality of regions, and
wherein, at least one of the denoising levels applied to a region of the plurality of regions is different from another denoising level applied to another region of the plurality of regions.

4. The apparatus of claim 1, wherein the sharpness information comprises a sharpening level applied to a region of the first image data.

5. The apparatus of claim 4,
wherein the first image data comprises a plurality of regions,
wherein the sharpness information comprises a plurality of sharpening levels,
wherein the one or more instructions, when executed by the at least one processor, cause the apparatus to apply a sharpening level from among the plurality of the sharpening levels to each of the plurality of regions, and
wherein, at least one of the sharpening levels applied to a region of the plurality of regions is different from another sharpening level applied to another region of the plurality of regions.

6. The apparatus of claim 1,
wherein the first image data comprises a plurality of regions,
wherein the one or more instructions, when executed by the at least one processor, cause the apparatus to:
apply a denoising level from among a plurality of denoising levels to each of the plurality of regions, and
apply a sharpening level from among a plurality of sharpening levels to each of the plurality of regions,
wherein the noise reduction information comprises a noise reduction map comprising the denoising levels applied to each of the plurality of regions of the first image data, and
wherein the sharpness information comprises a sharpness map comprising the sharpening levels applied to each of the plurality of regions of the first image data.

7. The apparatus of claim 6, wherein the one or more instructions, when executed by the at least one processor, cause the apparatus to:
generate at least one of the noise reduction map or the sharpness map based on the first image data.

8. The apparatus of claim 6, wherein the one or more instructions, when executed by the at least one processor, cause the apparatus to:
acquire semantic segmentation information associated with the first image data, and
generate at least one of the noise reduction map or the sharpness map based on the semantic segmentation information.

9. The apparatus of claim 6,
wherein the one or more instructions, when executed by the at least one processor, cause the apparatus to:
identify a face region among the plurality of regions of the first image data, and
generate the noise reduction map, wherein the noise reduction map further comprises a first denoising level, among the plurality of denoising levels, applied to the face region and a second denoising level, among the plurality of denoising levels, applied to at least a part of a region other than the face region among the plurality of regions of the first image data, and
wherein the first denoising level is different from the second denoising level.

10. The apparatus of claim 6,
wherein the one or more instructions, when executed by the at least one processor, cause the apparatus to:
identify a face region among the plurality of regions of the first image data, and
generate the sharpness map, wherein the sharpness map comprises a first sharpening level, among the plurality of sharpening levels, applied to the face region and a second sharpening level, among the plurality of sharpening levels, applied to at least a part of a region other than the face region among the plurality of regions of the first image data, and
wherein the first sharpening level is different from the second sharpening level.

11. The apparatus of claim 6,
wherein the one or more instructions, when executed by the at least one processor, cause the apparatus to:
acquire code information associated with the first image data, and
generate the noise reduction map based on the code information, wherein the noise reduction map comprises a first denoising level, among the plurality of denoising levels, applied to a first region among the plurality of regions of the first image data, and a second denoising level, among the plurality of denoising levels, applied to a second region among the plurality of regions of the first image data,
wherein the code information comprising illuminance-related information for each of the plurality of regions of the first image data,
wherein the first region and the second region are different from each other,
wherein a code value associated with the first region is less than a code value associated with the second region, and
wherein the first denoising level is higher than the second denoising level.

12. The apparatus of claim 6, wherein the one or more instructions, when executed by the at least one processor, cause the apparatus to:
acquire lens shading information associated with the pixel array, and
generate at least one of the noise reduction map or the sharpness map based on the lens shading information.

13. The apparatus of claim 12,
wherein the one or more instructions, when executed by the at least one processor, cause the apparatus to:
identify a central region and an outer region among the plurality of regions of the first image data based on the lens shading information, and
generate the noise reduction map, wherein the sharpness map comprises a first denoising level, among the plurality of denoising levels, applied to the central region, and a second denoising level, among the plurality of denoising levels, applied to the outer region, and
wherein the second denoising level is higher than the first denoising level.

14. The apparatus of claim 12,
wherein the one or more instructions, when executed by the at least one processor, cause the apparatus to:
identify a central region and an outer region among the plurality of regions of the first image data based on the lens shading information, and
generate the sharpness map, wherein the sharpness map comprises a first sharpening level, among the plurality of sharpening levels, applied to the central region, and a second sharpening level, among the plurality of sharpening levels, applied to the outer region, and
wherein the second sharpening level is lower than the first sharpening level.

15. The apparatus of claim 1, wherein the one or more instructions, when executed by the at least one processor, cause the apparatus to:
generate second image data associated with a second color pattern based on the first RGB image, and
generate a second RGB image by performing a demosaic operation on the second image data.

16. The apparatus of claim 15, wherein the second color pattern comprises a Bayer pattern.

17. The apparatus of claim 1, wherein the first image data, and at least one of the noise reduction information or the sharpness information, are input to the machine learning model in a concatenated state.

18. An image processing method comprising:
obtaining an optical signal through a pixel array configured to correspond to a first color pattern;
converting the optical signal to an electrical signal by the pixel array;
converting, through a readout circuit, the electrical signal into first image data associated with the first color pattern;
outputting, from the readout circuit, image data;
receiving the image data;
acquiring at least one of noise reduction information or sharpness information associated with the image data;
generating an RGB image by inputting the image data and at least one of the noise reduction information or the sharpness information into a machine learning model; and
outputting the RGB image.

19. The method of claim 18,
wherein the image data comprises a plurality of regions,
wherein the method further comprises:
applying a denoising level from among a plurality of denoising levels to each of the plurality of regions, and
applying a sharpening level from among a plurality of the sharpening levels to each of the plurality of regions,
wherein the noise reduction information comprises a noise reduction map comprising the denoising levels applied to each of the plurality of regions of the image data, and
wherein the sharpness information comprises a sharpness map comprising the sharpening levels applied to each of the plurality of regions of the image data.

20. A non-transitory computer readable medium having instructions stored therein, which when executed by at least one processor cause the at least one processor to execute an image processing method, the method comprising:
obtaining an optical signal through a pixel array configured to correspond to a first color pattern;
converting the optical signal to an electrical signal by the pixel array;
converting, through a readout circuit, the electrical signal into first image data associated with the first color pattern;
outputting, from the readout circuit, image data;
receiving the image data;
acquiring at least one of noise reduction information or sharpness information associated with the image data;
generating an RGB image by inputting the image data and at least one of the noise reduction information or the sharpness information into a machine learning model; and
outputting the RGB image.
